(19) United States
(12) Patent Application Publication
(10) Pub. No.: US 2026/0186642 A1
(43) Pub. Date: Jul. 2, 2026

(54) METHOD, APPARATUS, DEVICE AND STORAGE MEDIUM FOR GENERATING EFFECT

(71) Applicants: Lemon Inc., Grand Cayman (KY); Beijing Zitiao Network Technology Co., Ltd., Beijing (CN)

(72) Inventors: Guowei LYU, Culver City, CA (US); Shiyuan LIU, Culver City, CA (US); Runjia TIAN, Los Angeles, CA (US)

(21) Appl. No.: 19/425,961

(22) Filed: Dec. 18, 2025

(30) Foreign Application Priority Data
Dec. 31, 2024 (CN) 202411986774.6

(51) Int. Cl. G06F 3/04845; G06F 3/0482; G06F 40/166

(52) U.S. Cl. CPC G06F 3/04845; G06F 3/0482; G06F 40/166

(57) ABSTRACT

A method, an apparatus, a device, and a storage medium for generating an effect are provided. In a method, an interaction interface with a virtual object is presented, and the interaction interface includes a message interaction component and an effect preview component. A first message is obtained via an input control in the message interaction component, and the first message is configured to describe an effect to be generated. In response to a first effect being generated based on the first message, a second message associated with the first effect is presented in a message display area of the message interaction component, and preview content of the first effect is presented in the effect preview component.

### CROSS REFERENCE

The application claims priority to Chinese Patent Application No. 202411986774.6, filed on Dec. 31, 2024, and entitled “METHOD, APPARATUS, DEVICE AND STORAGE MEDIUM FOR GENERATING EFFECT”, the entire content of which is incorporated herein by reference.

### FIELD

Example embodiments of the present disclosure generally relate to the field of computers, and in particular, to a method, an apparatus, a device, and a computer-readable storage medium for generating an effect.

### BACKGROUND

With the development of computer technologies, Internet has become an important platform for creating and sharing media content. In the creation process of media content, video effects and picture effects are creation means frequently used by a user in the creation process. Such effects may enrich media content created by a user and enhance the degree of entertainment value of the content.

### SUMMARY

In a first aspect of the present disclosure, a method for generating an effect is provided. The method includes: presenting an interaction interface with a virtual object, the interaction interface including a message interaction component and an effect preview component; obtaining a first message via an input control in the message interaction component, the first message being configured to describe an effect to be generated; and presenting a second message associated with a first effect in a message display area of the message interaction component and presenting preview content of the first effect in the effect preview component in response to the first effect being generated based on the first message.

In a second aspect of the present disclosure, an apparatus for generating an effect is provided. The apparatus includes: an interface presenting module configured to present an interaction interface with a virtual object, the interaction interface including a message interaction component and an effect preview component; a message obtaining module configured to obtain a first message via an input control in the message interaction component, the first message being configured to describe an effect to be generated; and an information presenting module configured to present a second message associated with a first effect in a message display area of the message interaction component and present the preview content of the first effect in the effect preview component in response to the first effect being generated based on the first message.

In a third aspect of the present disclosure, an electronic device is provided. The electronic device includes at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The computer-readable storage medium has a computer program stored thereon, and the computer program is executable by a processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements. In the drawings:

FIG. 1 illustrates a schematic diagram of an example environment in which embodiments according to the present disclosure may be implemented;

FIGS. 2A-2F illustrate example interfaces according to some embodiments of the present disclosure;

FIG. 3 illustrates a flowchart of an example process of generating an effect according to some embodiments of the present disclosure;

FIG. 4 illustrates a schematic structural block diagram of an example apparatus for generating an effect according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as being limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the title of any section/subsection provided herein is not limiting. Various embodiments are described throughout, and any type of embodiment may be included in any section/subsection. Furthermore, the embodiments described in any section/subsection may be combined in any manner with any other embodiment described in the same section/subsection and/or different sections/subsections.

In the description of the embodiments of the present disclosure, the terms “including” and the like should be understood to mean an open-ended inclusion, i.e., “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first”, “second”, and the like may refer to different or identical objects. Other explicit and implicit definitions may also be included below.

Embodiments of the present disclosure may relate to data of a user, acquisition and/or use of data, and the like. These aspects all follow the corresponding laws and regulations and related provisions. In the embodiments of the present disclosure, all data collection, acquisition, treatment, processing, forwarding, use and the like are performed on the premise that the user knows and confirms. Accordingly, when implementing the embodiments of the present disclosure, the type, the usage scope, the usage scenario, and the like of the data or information that may be involved should be notified to the user and obtain the authorization from the user in an appropriate manner according to the relevant laws and regulations. The specific notification and/or authorization manner may vary according to actual situations and application scenarios, and the scope of the disclosure is not limited in this regard.

According to the solutions in the present specification and the embodiments, for example, personal information processing is involved, processing may be performed on the premise of having a legal basis (for example, obtaining consent of a personal information subject, or necessary for performing a fulfillment contract), and processing may be performed only within a specified or agreed range. In the case that the user refuses personal information other than necessary information required by the basic function, the use of the basic function by the user will not be affected.

According to the traditional solution, video effects and picture effects are creation means frequently used by a user in the creation process. Such effects may enrich media content created by a user and enhance the degree of entertainment value of the content. Conventionally, the user needs to click the preview to view a preview effect image of a target effect, thereby affecting the user experience.

An embodiment of the present disclosure provides a solution for generating an effect. According to the solution, an interaction interface with a virtual object may be presented, and the interaction interface includes a message interaction component and an effect preview component. A first message is obtained via an input control in the message interaction component, and the first message is configured to describe an effect to be generated. In response to a first effect being generated based on the first message, a second message associated with the first effect is presented in a message display area of the message interaction component, and preview content of the first effect is presented in the effect preview component.

In this way, the embodiments of the present disclosure may enable the user to more intuitively perceive an application effect of the effect generated by the virtual object, thereby improving the generation efficiency of the effect.

Various example implementations of this solution are described in detail below in conjunction with the accompanying drawings.

### Example Environment

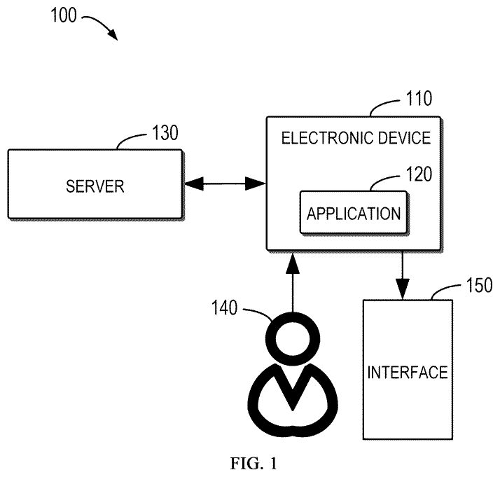

FIG. 1 illustrates a schematic diagram of an example environment 100 in which embodiments of the present disclosure may be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include, but are not limited to: an effect editing application, a video application, a social application, or other suitable applications. The user 140 may interact with the application 120 via the electronic device 110 and/or its attachment device.

In the environment 100 of FIG. 1, if the application 120 is in an active state, the electronic device 110 may present, via the application 120, an interface 150 for supporting interface interaction.

In some embodiments, the electronic device 110 communicates with a server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be a standalone physical server, a distributed system or a server cluster composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for the applications 120 that support content presentation in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this regard. In the embodiment of the present disclosure, the server 130 and the electronic device 110 may implement signaling interaction through the communication connection between the server 130 and the electronic device 110.

It should be understood that the structures and functions of various elements in the environment 100 are described for illustrative purposes only and do not imply any limitation to the scope of the present disclosure.

Some example embodiments of the present disclosure will be described below with continued reference to the accompanying drawings.

### Example Interaction

Hereinafter, a process of generating an effect according to an embodiment of the present disclosure will be described with reference to the accompanying drawings.

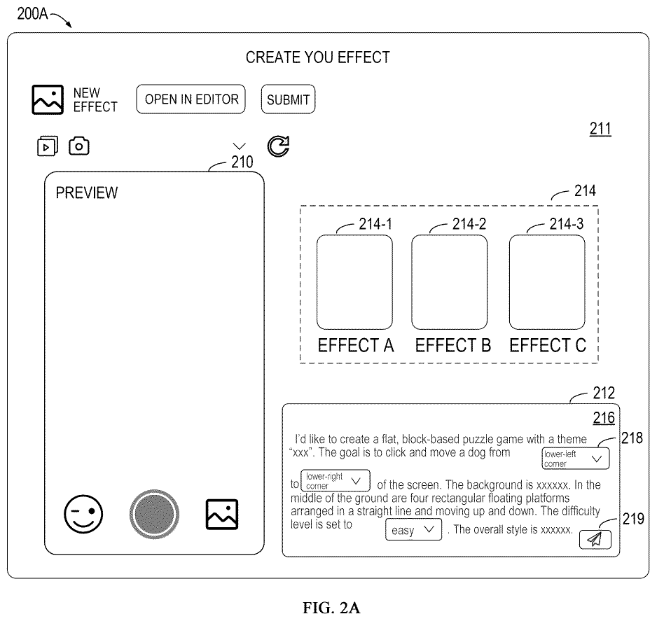

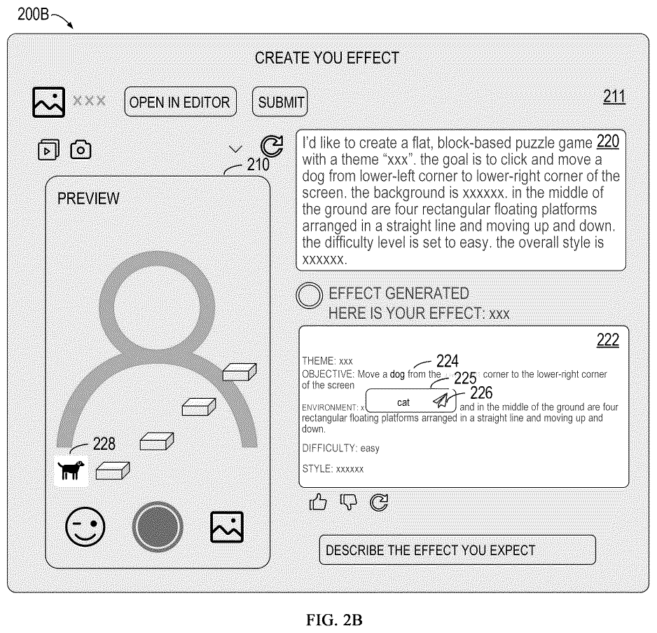

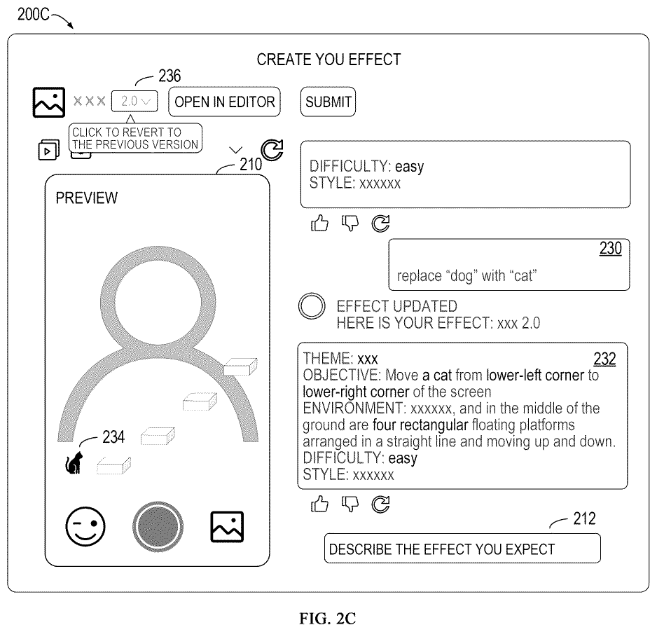

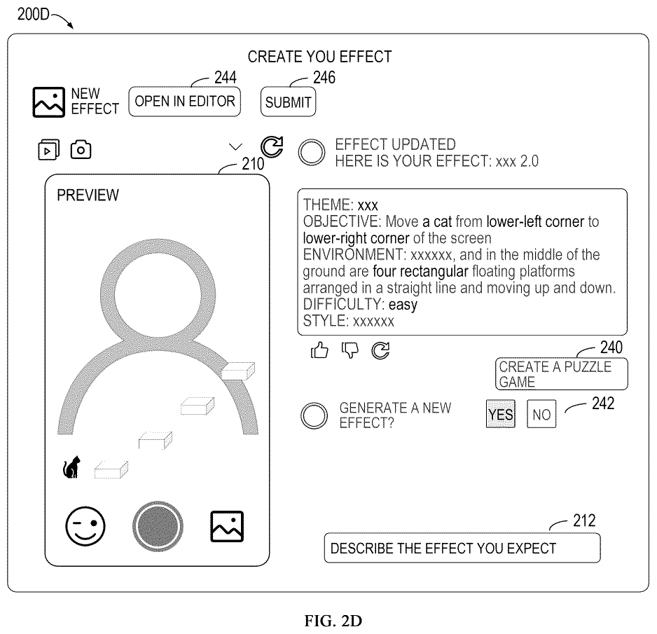

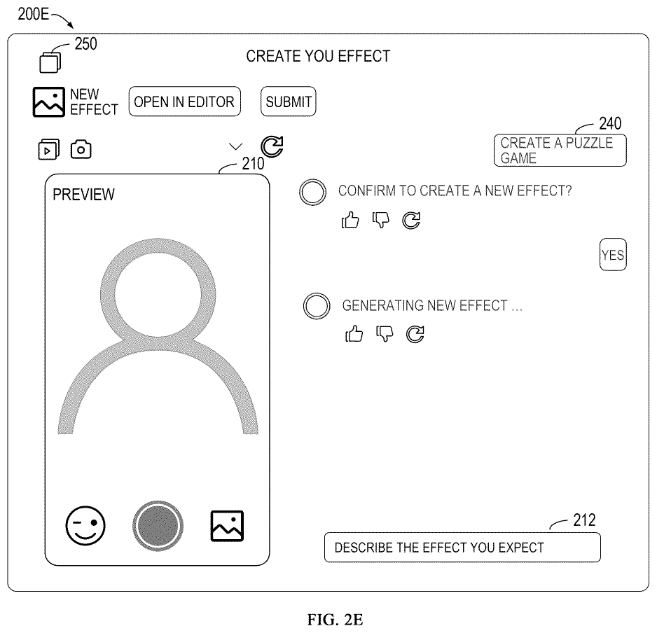

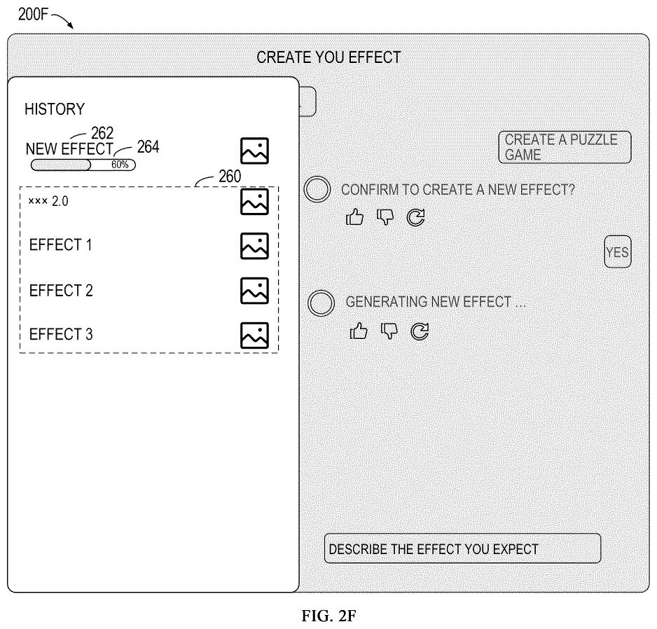

FIGS. 2A-2F illustrate example interfaces 200A-200F according to some embodiments of the present disclosure. The interfaces 200A-200F may be provided by the electronic device 110 shown in FIG. 1.

As shown in FIG. 2A, the interface 200A may be, for example, an interaction interface between a user and a virtual object. In some embodiments, the virtual object may include any suitable processing entity that supports generating and/or editing effects in a manner such as a prompt item. In some scenarios, the virtual object may also be referred to as a virtual entity, examples of which may include, but are not limited to, an agent, a bot, or other processing entities that support triggering effects editing through chats, etc. Such a virtual object may be implemented, for example, using an appropriate machine learning mode to generate and/or edit effects accordingly based on the received prompt item. The present disclosure is not intended to limit the specific construction manner of the virtual object.

In some embodiments, as shown in FIG. 2A, the interaction interface 200A may include an effect preview component 210 and a message interaction component 211. The effect preview component 210 may be used for the user to preview and edit the generated effects in real time. The message interaction component 211 may include, but is not limited to, an input control 212 and content such as a chat message between a user and a virtual object or the like. The input control 212 may be configured to input any appropriate type of messages sent by the user to the virtual object, for example, a text message, a voice message, or the like. It may be understood that the present disclosure is not intended to limit positions of the effect preview component 210 and the message interaction component 211.

In some embodiments, an input message (a first message) of the user may be directly provided to the virtual object, or may be appropriately processed and then provided to the virtual object as a prompt item for describing the effect to be generated.

In some other embodiments, to improve the input efficiency of the prompt item, the electronic device 110 may also present a set of candidate templates in the interaction interface 200A, for example, a template 214-1, a template 214-2, and a template 214-3 (individually or collectively referred to as a template 214). The electronic device 110 may also associatively present an effect style of each template 214, for example, a presentation style of an effect corresponding to the template 214.

As an example, the electronic device 110 may receive a selection for a target template 214-1, and may accordingly display a predetermined prompt item 216 corresponding to the target template 214-1 in the input control 212.

Further, the user may also, for example, edit the predetermined prompt item 216 and/or directly use the predetermined prompt item 216 as a message input to the virtual object. For example, the user may delete a part of text in the predetermined prompt item 216, modify a part of the text, or add additional text.

In some embodiments, as shown in FIG. 2A, the electronic device 110 may further display one or more parameters, for example, a parameter 218, in the predetermined prompt item 216 by using a target style. Such a target style may, for example, be presented in the form of an interaction component. As an example, the electronic device 110 may receive a predetermined operation (e.g., a click operation or a hover operation) of the user for the parameter 218, and may display a set of candidate parameters that may be used to replace the parameter 218. For example, candidate values for the parameter 218 may include “upper right corner”, “upper left corner”, and “lower right corner”.

In this way, the user may edit the predetermined prompt item 216 by selecting the “upper right corner” in the set of candidate parameters, to generate description text meeting the user's effect creation requirements.

In addition, in order to provide more effect styles for the user to select, the electronic device 110 may also provide a refresh component (not shown) in the chat interface 200A, for example. The electronic device 110 may, for example, receive a user's trigger for the refresh component and display a new set of candidate templates accordingly. For example, the templates 214-1 to 214-3 may be replaced with other three candidate templates.

Based on this manner, the embodiments of the present disclosure may help a user to more efficiently edit a message for describing an effect, thereby improving the efficiency of effect generation. In addition, such predetermined prompt items may, for example, have relatively good quality of generation. In this way, the embodiments of the present disclosure may further provide quality of effect generation.

In summary, the user may freely input a message for describing an effect via the input control 212, or the user may input a message for describing an effect based on the editing of the predetermined prompt item 216. Further, the electronic device 110 may receive a selection of the control 219 by the user to trigger sending the input message to the virtual object for effect generation.

Further, as shown in FIG. 2B, the electronic device 110 may present a first message 220 from the user in an interaction interface 200B. Further, in response to a first effect being generated based on the first message 220, the electronic device 110 may present a second message 222 from the virtual object in a message display area of the message interaction component 211. In some embodiments, such a second message 222 may be configured, for example, to describe an understanding of the first message 220 input by the user, and/or description information describing a set of attributes of the generated first effect.

In some embodiments, such a set of attributes may be determined based on a type of the first effect generated by the electronic device 110. Such a second message 222 may be generated based on a preset attribute, and different types of effects may correspond to different types of attributes. Correspondingly, the electronic device 110 may determine a corresponding attribute based on the generated characteristic of the effect, and generate the description information about the effect according to the attribute. As an example, such a set of attributes may indicate, for example, a subject, a target, an environment, a degree of difficulty, a style, and the like in the first message 220.

Further, the electronic device 110 may also present preview content of the first effect in the effect preview component 210 in response to the first effect being generated based on the first message 220. Such an effect preview component 210 may be, for example, that the electronic device 110 invokes a corresponding image acquisition device to provide a real-time preview of the effect.

Thus, the embodiments of the present disclosure may help the user to visually perceive the application effect of the effect generated by the virtual object.

With continued reference to FIG. 2B, in some embodiments, the electronic device 110 may also display one or more parameters (a first parameter), e.g., a parameter 224, in the second message 222 in a target style. As an example, the electronic device 110 may process, e.g., by highlighting or bolding, one or more parameters in the second message 222 to make it different from other content, thereby facilitating the user to more intuitively view the content available for modification.

In some embodiments, the electronic device 110 may present an editing window 225 in response to a selection of the parameter 224 (e.g., a dog) by the user. Further, the user may input the content intended to be replaced based on the editing window 225. As an example, the user may replace the parameter “dog” with “cat”. In other embodiments, the electronic device 110 may also provide a set of candidate parameters for user to select based on parameters selected by the user.

In some embodiments, in response to a trigger by user for the target content in the second message, the electronic device 110 may highlight, in the effect preview component 210, an effect element corresponding to the target content, for example, the effect element is highlighted or a contour of the effect element is displayed, thereby facilitating the user to view. As an example, such target content may be, for example, the parameter 224 (for example, a dog) in the second message, and the effect element may be a dog avatar 228 corresponding to the parameter 224. Further, in response to the target content being edited, the electronic device 110 may update the effect element corresponding to the target content in the effect preview component 210.

In some other embodiments, the electronic device 110 may further display, in response to a trigger by user for a target effect element in the first effect, the target effect element in a target style. For example, the target effect element may be highlighted and displayed, or a contour of the effect element may be displayed, etc. Further, the electronic device 110 may determine a target parameter corresponding to the target effect element in the second message 222, and the target parameter may be presented in a style different from that of other text in the second message 222. In addition, the electronic device 110 may also provide an editing window associated with the target parameter for the user to input the content intended to be replaced.

In still other embodiments, the electronic device 110 may present, in response to a trigger operation by the user on the target effect element in the effect preview component 210, a plurality of candidate effect elements for user to select. Additionally or alternatively, the electronic device 110 may further overlay, in the effect preview component 210, the copied effect element onto the target effect element based on the user operation, to implement replacement of the target effect element in the effect.

In this way, the electronic device 110 may link the parameter in the message with the effect element in the effect, so that the user may more accurately control the content that needs to be replaced, and the user experience is improved.

Further, referring to FIG. 2C, the electronic device 110 may present, in response to the user completing the above replacement operation, a message 230 from the user in an interaction interface 200C, for example, “please replace the ‘dog’ with ‘cat’. Further, the electronic device 110 may also present a message 232 from the virtual object. In some embodiments, such a message 232 may be presented in a form similar to that of the second message 222, and details are not described herein again.

Further, while the message 232 is presented, the electronic device 110 may further re-generate an effect after the effect element 228 is replaced with the effect element 234 in the effect preview component 210.

In some embodiments, the electronic device 110 may also support the user to further adjust the generated effect by inputting a new message. Specifically, the electronic device 110 may, for example, obtain an input message of the user via the input control 212. Such an input message may, for example, describe an editing request for the generated effect. For example, such an input message may indicate modification on a style of an animation, an effect of an image, or the like in the effect.

Further, the electronic device 110 may accordingly present a message from the virtual object in the interaction interface 200C. Similarly, the message may include description information about the edited first effect, and an interaction component corresponding to the edited first effect, to support the user to preview the edited effect, edit the edited effect in an editing tool, and/or posting the edited effect.

In some embodiments, the electronic device 110 may further provide a predetermined control 236 in the interaction interface 200C for the user to switch the first effect into the previous version, thereby improving the user experience.

According to the above, the first effect involved is associated with a first chat.

Further, in order to realize the generation of a new effect, the electronic device 110 may further support the user to generate a new effect by inputting a new message (a third message). Taking FIG. 2D as an example, the electronic device 110 may obtain a message 240 input by the user via the input control 212, for example, “generate a “puzzle game”. The electronic device 110 may present a reminder message in response to determining that the user's request is to generate a new effect. Specifically, the electronic device 110 may accordingly present a reminder message 242 from the virtual object in an interaction interface 200D, i.e., “generate a new effect? yes or no”. Further, in response to a selection of “yes” by the user, the electronic device 110 may generate a new effect corresponding to the message 240 based on the virtual object.

Further, the electronic device 110 may present an interaction interface 200E as shown in FIG. 2E, and the interaction interface 200E may be associated with a second chat. As an example, the electronic device 110 may update an interaction interface 400D, so that the first chat is no longer displayed, and only the second chat is displayed. In addition, the effect in the effect preview component 210 may also be reset to an effect corresponding to the third message. That is, in the case that a new effect is generated based on the virtual object, the electronic device 110 may automatically switch the preview effect component 210 to display the preview content about the new effect.

Further, in some embodiments, in response to determining a confirmation for the reminder message by the user, the electronic device 110 may save the first effect on a per-effect basis. In some embodiments, the electronic device 110 may automatically save the first effect, or the electronic device 110 may determine whether to save the first effect based on an operation of the user.

With continued reference to FIG. 2E, in order to facilitate the user to view a historical effect, the electronic device 110 may further provide a historical viewing entry in the interface 200E, and the historical viewing entry may be presented, for example, in the form of a predetermined control 250. Further, in response to a selection of the predetermined control 250 by the user, the electronic device 110 may present a set of historical effects 260 (e.g., ×××2.0, effect 1, effect 2, effect 3) and/or a new effect 262 that is being generated as shown in FIG. 2F. In some embodiments, ×××2.0 may indicate, for example, version information of the historical effect ×××, that is, the effect of ×××has two versions, and the electronic device 110 may present a final version effect of the ×××2.0 effect in the interaction interface in response to a selection of the ×××2.0 effect by the user, and may switch to the previous version based on the user's operation in the interaction interface.

In some embodiments, the electronic device 110 may also present a generation progress of the new effect 262 being generated in an interface 200F. For example, the electronic device 110 may show that the generation progress of the new effect 262 is 60% based on a progress bar 264.

Further, in response to a selection of the target effect (the second effect) of the set of historical effects 260 by the user, the electronic device 110 may associate the interaction interface with a third chat corresponding to the target effect. That is, the electronic device 110 may present the preview content of the second effect in the effect preview component 210 in the interaction interface, and present, in the message interaction component 211, the third chat corresponding to the second effect.

With continued reference to FIG. 2D, the electronic device 110 may also provide a first control and a second control in an interface 200D, such as an editing control 244 and a posting control 246. In some examples, in response to receiving a selection of the editing control 244, the electronic device 110 may import the generated first effect into an effect editing tool to present an editing interface of the first effect, thereby supporting further editing of the first effect. In still other examples, in response to receiving a selection of the posting control 246, the electronic device 110 may post the first effect generated by the virtual object, so that other users may obtain and use the effect.

In this way, the embodiments of the present disclosure may generate, edit and preview an effect in real time in a chat manner, greatly reducing the learning cost of the user, and improving the generation efficiency and the generation quality of the effect. Further, the embodiments of the present disclosure may further enable the user to more intuitively perceive the application effect of the effect generated by the virtual object.

### Example Process

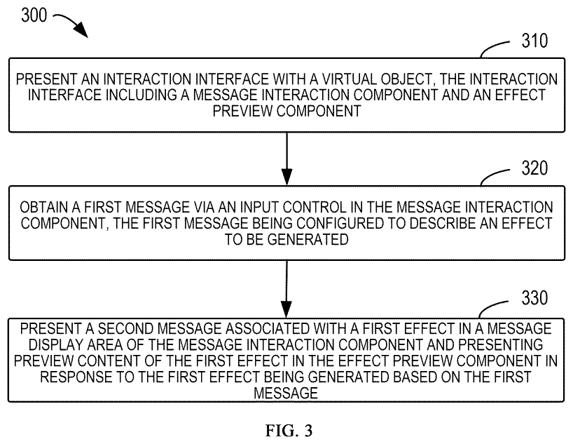

FIG. 3 illustrates a flowchart of an example process 300 for generating an effect according to some embodiments of the present disclosure. Process 300 may be implemented at electronic device 110. The process 300 is described below with reference to FIG. 1.

As shown in FIG. 3, at block 310, the electronic device 110 presents an interaction interface with a virtual object, and the interaction interface includes a message interaction component and an effect preview component.

At block 320, the electronic device 110 obtains a first message via an input control in the message interaction component, and the first message is configured to describe an effect to be generated.

At block 330, the electronic device 110 presents a second message associated with a first effect in a message display area of the message interaction component and presents preview content of the first effect in the effect preview component in response to the first effect being generated based on the first message.

In some embodiments, the second message includes description information describing a set of attributes of the first effect.

In some embodiments, the set of attributes is determined based on a type of the generated first effect.

In some embodiments, the process 300 further includes: displaying a first parameter in the description information in a target style; presenting, in response to a first operation on the first parameter, an editing window associated with the first parameter; replacing the first parameter with a second parameter via an editing operation received in the editing window; and triggering an update of the first effect based on the second parameter.

In some embodiments, the editing operation includes: obtaining the second parameter input via the editing window; or receiving a selection of the second parameter of at least one candidate parameter presented in the editing window.

In some embodiments, the process 300 further includes: adjusting, in response to a selection of a target content in the second message, a style of at least one effect element corresponding to the target content in the effect preview component.

In some embodiments, the process 300 further includes: updating, in response to the target content being edited, the at least one effect element in the effect preview component.

In some embodiments, the interaction interface is associated with a first chat corresponding to the first effect, and the process 300 further includes: obtaining, via the input control, a third message indicating a request to generate a new effect; and associating the interaction interface with a second chat corresponding to the new effect.

In some embodiments, associating the interaction interface with the second chat includes: presenting a reminder message in response to the third message indicating the request to generate the new effect; and associating the interaction interface with the second chat in response to a confirmation for the reminder message.

In some embodiments, the process 300 further includes: presenting a set of historical effects in response to a selection of a historical viewing entry in the interaction interface; and associating, in response to a selection of a second effect of the set of historical effects, the interaction interface with a third chat corresponding to the second effect.

In some embodiments, obtaining the first message via the input control in the message interaction component includes: presenting a set of candidate templates in the interaction interface; displaying, based on a selection of a target template from the set of candidate templates, a predetermined prompt item corresponding to the target template in the input control of the interaction interface; and obtaining the first message determined based on the predetermined prompt item.

In some embodiments, the process 300 further includes: presenting an editing interface of the first effect in response to a first operation on a first control in the interaction interface; and/or posting the first effect in response to a second operation on a second control in the interaction interface.

### Example Apparatus and Device

Embodiments of the present disclosure also provide a corresponding apparatus for implementing the above method or process. FIG. 4 is a schematic structural block diagram of an example apparatus 400 for generating an effect according to some embodiments of the present disclosure. The apparatus 400 may be implemented or included in the electronic device 110. Various modules/components in the apparatus 400 may be implemented by hardware, software, firmware, or any combination thereof.

As shown in FIG. 4, the apparatus 400 includes an interface presenting module 410 configured to present an interaction interface with a virtual object, the interaction interface including a message interaction component and an effect preview component; a message obtaining module 420 configured to obtain a first message via an input control in the message interaction component, the first message being configured to describe an effect to be generated; and an information presenting module 430 configured to present a second message associated with a first effect in a message display area of the message interaction component and present preview content of the first effect in the effect preview component in response to the first effect being generated based on the first message.

In some embodiments, the second message includes description information describing a set of attributes of the first effect.

In some embodiments, the set of attributes is determined based on a type of the generated first effect.

In some embodiments, the apparatus 400 further includes a first processing module configured to display a first parameter in the description information in a target style; present, in response to a first operation on the first parameter, an editing window associated with the first parameter; replace the first parameter with a second parameter via an editing operation received in the editing window; and trigger an update of the first effect based on the second parameter.

In some embodiments, the editing operation includes: obtaining the second parameter input via the editing window; or receiving a selection of the second parameter of at least one candidate parameter presented in the editing window.

In some embodiments, the apparatus 400 further includes a second processing module configured to adjust, in response to a selection of a target content in the second message, a style of at least one effect element corresponding to the target content in the effect preview component.

In some embodiments, the apparatus 400 further includes a third processing module configured to update, in response to the target content being edited, the at least one effect element in the effect preview component.

In some embodiments, the interaction interface is associated with a first chat corresponding to the first effect, and the apparatus 400 further includes a fourth processing module configured to obtain, via the input control, a third message indicating a request to generate a new effect; and associate the interaction interface with a second chat corresponding to the new effect.

In some embodiments, the fourth processing module is further configured to present a reminder message in response to the third message indicating the request to generate the new effect; and associate the interaction interface with the second chat in response to a confirmation for the reminder message.

In some embodiments, the apparatus 400 further includes a fifth processing module configured to present a set of historical effects in response to a selection of a historical viewing entry in the interaction interface; and associating, in response to a selection of a second effect of the set of historical effects, the interaction interface with a third chat corresponding to the second effect.

In some embodiments, the message obtaining module 420 is further configured to present a set candidate templates in the interaction interface; display, based on a selection of a target template from the set of candidate templates, a predetermined prompt item corresponding to the target template in the input control of the interaction interface; and obtain the first message determined based on the predetermined prompt item.

In some embodiments, the apparatus 400 further includes a sixth processing module configured to present an editing interface of the first effect in response to a first operation on a first control in the interaction interface; and/or post the first effect in response to a second operation on a second control in the interaction interface.

The modules included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the modules in the apparatus 400 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

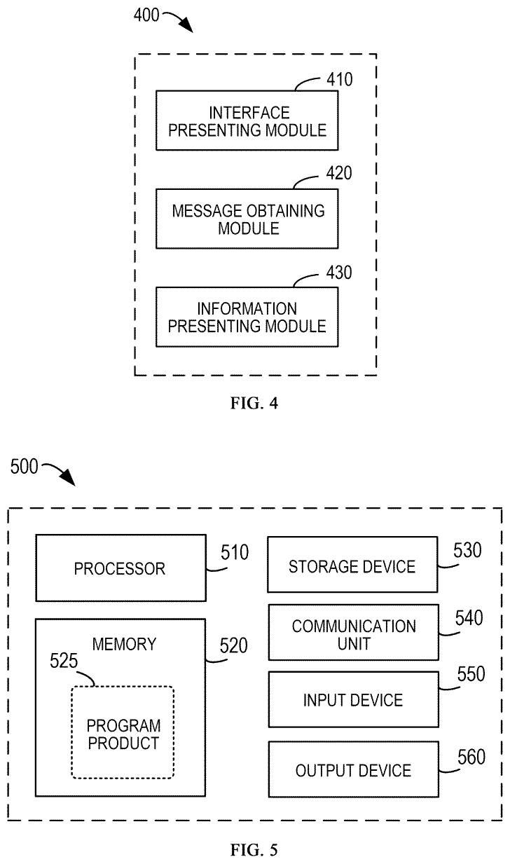

As shown in FIG. 5, the electronic device 500 is in a form of a general-purpose electronic device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In a multiprocessor system, a plurality of processing units executes computer-executable instructions in parallel to improve the parallel processing capability of the electronic device 500.

The electronic device 500 generally includes a plurality of computer storage media. Such media may be any available media that is accessible by the electronic device 500, including, but not limited to, volatile and non-volatile media, removable and non-removable media. The memory 520 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 530 may be a removable or non-removable medium and may include a machine-readable medium, such as a flash drive, a magnetic disk, or any other medium, which may be capable of storing information and/or data and may be accessed within the electronic device 500.

The electronic device 500 may further include additional removable/non-removable, volatile/non-volatile storage media. Although not shown in FIG. 5, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the disclosure.

The communication unit 540 is configured to communicate with other electronic device through a communication medium. Additionally, the functionality of components of the electronic device 500 may be implemented in a single computing cluster or multiple computing machines capable of communicating through a communication connection. Thus, the electronic device 500 may operate in a networked environment using logical connections with one or more other servers, a network profile computer (PC), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, the external device such as a storage device, a display device, etc., communicates with one or more devices that enable the user to interact with the electronic device 500, or communicates with any device (e.g., a network card, a modem, etc.) that enables the electronic device 500 to communicate with one or more other electronic devices. Such communication may be executed via an input/output (I/O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, a computer program product is further provided, the computer program product being tangibly stored on a non-transitory computer-readable medium and including computer-executable instructions, and the computer-executable instructions being executed by the processor to implement the method described above.

Aspects of the disclosure are described herein with reference to flowcharts and/or block diagrams of a method, an apparatus, a device, and a computer program product implemented in accordance with the disclosure. It should be understood that each block of the flowchart and/or block diagram, and combinations of blocks in the flowchart(s) and/or block diagram(s), may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in one or more blocks in the flowchart(s) and/or block diagram(s). These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on the computer, other programmable data processing apparatus, or other apparatus implement the functions/acts specified in one or more blocks in the flowchart(s) and/or block diagram(s).

The flowchart and block diagrams in the figures show an architecture, functionality, and operation that may be possibly implemented by a system, a method, and a computer program product according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagram(s) and/or flowchart(s), as well as combinations of blocks in the block diagram(s) and/or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for generating an effect, comprising:
presenting an interaction interface with a virtual object, the interaction interface comprising a message interaction component and an effect preview component;
obtaining a first message via an input control in the message interaction component, the first message being configured to describe an effect to be generated; and
presenting a second message associated with a first effect in a message display area of the message interaction component and presenting preview content of the first effect in the effect preview component in response to the first effect being generated based on the first message.

2. The method of claim 1, wherein the second message comprises description information describing a set of attributes of the first effect.

3. The method of claim 2, wherein the set of attributes is determined based on a type of the generated first effect.

4. The method of claim 2, further comprising:
displaying a first parameter in the description information in a target style;
presenting, in response to a first operation on the first parameter, an editing window associated with the first parameter;
replacing the first parameter with a second parameter via an editing operation received in the editing window; and
triggering an update of the first effect based on the second parameter.

5. The method of claim 4, wherein the editing operation comprises:
obtaining the second parameter input via the editing window; or
receiving a selection of the second parameter of at least one candidate parameter presented in the editing window.

6. The method of claim 1, further comprising:
adjusting, in response to a selection of a target content in the second message, a style of at least one effect element corresponding to the target content in the effect preview component.

7. The method of claim 6, further comprising:
updating, in response to the target content being edited, the at least one effect element in the effect preview component.

8. The method of claim 1, wherein the interaction interface is associated with a first chat corresponding to the first effect, and the method further comprises:
obtaining, via the input control, a third message indicating a request to generate a new effect; and
associating the interaction interface with a second chat corresponding to the new effect.

9. The method of claim 8, wherein associating the interaction interface with the second chat comprises:
presenting a reminder message in response to the third message indicating the request to generate the new effect; and
associating the interaction interface with the second chat in response to a confirmation for the reminder message.

10. The method of claim 8, further comprising:
presenting a set of historical effects in response to a selection of a historical viewing entry in the interaction interface; and
associating, in response to a selection of a second effect of the set of historical effects, the interaction interface with a third chat corresponding to the second effect.

11. The method of claim 1, wherein obtaining the first message via the input control in the message interaction component comprises:
presenting a set of candidate templates in the interaction interface;
displaying, based on a selection of a target template from the set of candidate templates, a predetermined prompt item corresponding to the target template in the input control of the interaction interface; and
obtaining the first message determined based on the predetermined prompt item.

12. The method of claim 1, further comprising:
presenting an editing interface of the first effect in response to a first operation on a first control in the interaction interface; and/or posting the first effect in response to a second operation on a second control in the interaction interface.

13. An electronic device, comprising:
at least one processor; and
at least one memory coupled to the at least one processor and storing instructions for execution by the at least one processor, the instructions, when executed by the at least one processor, causing the electronic device to perform acts comprising:
presenting an interaction interface with a virtual object, the interaction interface comprising a message interaction component and an effect preview component;
obtaining a first message via an input control in the message interaction component, the first message being configured to describe an effect to be generated; and
presenting a second message associated with a first effect in a message display area of the message interaction component and presenting preview content of the first effect in the effect preview component in response to the first effect being generated based on the first message.

14. The electronic device of claim 1, wherein the second message comprises description information describing a set of attributes of the first effect.

15. The electronic device of claim 14, wherein the acts further comprise:
displaying a first parameter in the description information in a target style;
presenting, in response to a first operation on the first parameter, an editing window associated with the first parameter;
replacing the first parameter with a second parameter via an editing operation received in the editing window; and
triggering an update of the first effect based on the second parameter.

16. The electronic device of claim 13, wherein the acts further comprise:
adjusting, in response to a selection of a target content in the second message, a style of at least one effect element corresponding to the target content in the effect preview component.

17. The electronic device of claim 13, wherein the interaction interface is associated with a first chat corresponding to the first effect, and the method further comprises:
obtaining, via the input control, a third message indicating a request to generate a new effect; and
associating the interaction interface with a second chat corresponding to the new effect.

18. The electronic device of claim 13, wherein obtaining the first message via the input control in the message interaction component comprises:
presenting a set of candidate templates in the interaction interface;
displaying, based on a selection of a target template from the set of candidate templates, a predetermined prompt item corresponding to the target template in the input control of the interaction interface; and
obtaining the first message determined based on the predetermined prompt item.

19. The electronic device of claim 13, wherein the acts further comprise:
presenting an editing interface of the first effect in response to a first operation on a first control in the interaction interface; and/or posting the first effect in response to a second operation on a second control in the interaction interface.

20. A computer program product tangibly stored on a non-transitory computer-readable medium and comprising computer-executable instructions, the computer-executable instructions being executable by a processor to perform acts comprising:
presenting an interaction interface with a virtual object, the interaction interface comprising a message interaction component and an effect preview component;
obtaining a first message via an input control in the message interaction component, the first message being configured to describe an effect to be generated; and
presenting a second message associated with a first effect in a message display area of the message interaction component and presenting preview content of the first effect in the effect preview component in response to the first effect being generated based on the first message.
